(19) United States
(12) Patent Application Publication
(10) Pub. No.: US 2009/0240945 A1
(43) Pub. Date: Sep. 24, 2009

(54) ANTICOUNTERFEITING MEANS FOR OPTICAL COMMUNICATION COMPONENTS

(75) Inventor: Lewis B. Aronson, Los Altos, CA (US)

Correspondence Address: Workman Nydegger;1000 Eagle Gate Tower, 60 East South Temple, Salt Lake City, UT, 84111, US

(73) Assignee: FINISAR CORPORATION, Sunnyvale, CA (US)

(21) Appl. No.: 12/264,194

(22) Filed: Nov. 3, 2008

Related U.S. Application Data
(60) Provisional application No. 60/985,131, filed on Nov. 2, 2007.

(51) Int. Cl. H04L 9/32; H04K 1/00

(52) U.S. Cl. 713/176; 380/256

(57) ABSTRACT

Methods and systems for detecting counterfeit optical communications products are described. An exemplary system includes a host device and a fiber optic component, such as an optical transceiver. The optical transceiver may include a TOSA, a ROSA, a controller circuit, and a memory module. The controller circuit may be operably connected to the TOSA, the ROSA, and the memory module. The host device may send a set of challenge data to the optical transceiver. The optical transceiver may respond with a data set encrypted by the controller circuit using a secret key stored in the memory module. The encrypted response data set may be evaluated to determine whether the optical transceiver is authenticate.

### CROSS-REFERENCE TO RELATED APPLICATIONS

The present application claims the benefit of and priority to U.S. Provisional Application Ser. No. 60/985,131, entitled “ANTICOUNTERFEITING MEANS FOR OPTICAL COMMUNICATION COMPONENTS,” filed Nov. 2, 2007, which application is fully incorporated herein by reference in its entirety.

### BACKGROUND OF THE INVENTION

1. The Field of the Invention

The present invention relates generally to the field of optical communications and more specifically to methods and systems for detecting counterfeit optical communications products.

2. The Related Technology

Fiber optic transmissions systems have become increasingly important in data communications and telecommunications systems as data rates have risen to rates of 1 Gb/s and beyond. Local area network, storage area network, and wide area network systems generally employ fiber optic communication links for data rates of 1 Gb/s and above and for distances beyond a few meters. One arrangement for interconnecting two pieces of networking equipment is through the use of pluggable fiber optic transceivers, which are in turn connected over a fiber optic cable. The networking equipment will typically provide an electrical port with standardized mechanical and electronic specifications, which will accept an optical transceiver module meeting the same specifications. One example of such a specification is the Small Form-factor Pluggable (“SFP”) transceiver which operates at data rates from 1-4 Gb/s. A number of other transceiver form factor standards exist such as the SFP+ (8-10 Gb/s), and 10 Gb/s XFP, X2, XPAK and XENPAK standards.

Another arrangement for interconnecting networking equipment uses an active optical cable, which integrates the function of a fiber optic transceiver into a plug at each end of a fiber optic cable. In this arrangement, benefits of fiber communication (e.g., high data rates over long distances with a thin cable) may be achieved with the external functionality of an electrical cable.

Equipment manufacturers and end users have an interest in taking anticounterfeiting measures to ensure authenticity of components in both pluggable cables and active optical cables. There are at least two reasons for this interest. First, authentication of components may ensure high performance and reliability of each component in a link, thereby ensuring overall reliability of the link. Second, authentication limits the use of third party components, which, unlike qualified optical link components, are not likely to have been extensively tested and qualified to guarantee an overall system performance. Thus, use of untested third party components can erode unit prices and revenues in sales of qualified optical link components to both end users and value added retailers.

Some networking systems attempt to automatically reject unqualified or counterfeit components through the use of management control interfaces in fiber optic transceiver standards. A management interface in the SFF-8472 standard specifies and provides pins for a low speed serial communication link based on the memory mapped Inter-Integrated Circuit (“I2C”) standard for use in link management functions. See SFF-8472 rev 10.2, Diagnostic Monitoring Interface for Optical Transceivers, SFF Committee, Jun. 1, 2007. The SFF-8472 standard allocates memory space for vendor specific and user link management functions. These functions include identification functions, which allow a host device to read static information such as a transceiver manufacturer's name, serial number, and manufacturing date. These functions also include diagnostic functions, which allow the host device to monitor the temperature, received power, laser bias current, and other dynamic parameters.

One anti-counterfeiting method may entail programming, at a transceiver manufacturer, a section of local memory readable through the management interface with a special authentication code provided by the manufacturer. Alternatively, a special authentication code may be derived from a transceiver's serial ID information using a secret algorithm. The host devices are configured to reject (i.e., not allow a working link with) a transceiver that fails to provide a proper value in the designated memory location. However, this authentication method may be overcome by copying the memory contents of an authentic component into the local memory of a counterfeit component. Moreover, although host devices can be designed to detect use of the same special code or serial number in multiple components, an entire set of authentic components may be replicated into a set of counterfeit components such that components with unique, valid memory contents can be used in each of a system's ports (typically up to 48).

Counterfeiting of passive components (such as the optical cable used between two transceivers) is also a concern. Such components may lack the serial communications means described above in connection with optical transceivers. Anticounterfeiting measures, such as unique, difficult to reproduce labeling, are possible with such components, though generally they are not practiced.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF SOME EXAMPLE EMBODIMENTS

In general, example embodiments of the invention relate to methods and systems for detecting counterfeit optical communications products.

In one example embodiment, an optoelectronic device comprises a TOSA, a ROSA, a controller, and a memory module. The controller is operably connected to the TOSA and the ROSA. The memory module is operably connected to the controller circuit and stores a key. The controller circuit is adapted to authenticate the optoelectronic device by receiving challenge data from a host device and sending encrypted response data to the host device using the key.

In another example embodiment, a system comprises a host device and a fiber optic component. The fiber optic component comprises a controller circuit and a memory module. The memory module is operably connected to the controller circuit and stores a key. The controller circuit is adapted to authenticate the fiber optic component by receiving challenge data from the host device and sending encrypted response data to the host device using the key.

In yet another example embodiment, a method of authenticating a fiber optic component includes a host device generating a challenge data set. The host device writes the challenge data set to authentication memory of the fiber optic component. The host device reads a response data set from the authentication memory of the fiber optic component, the response data set comprising an encryption of the challenge data set. The host device verifies that the response data set is encrypted using a predetermined key and encryption algorithm. When the response data set is encrypted using the predetermined key and encryption algorithm, the host device enables a communication link with the fiber optic component.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates an example fiber optic transceiver;

FIG. 2 illustrates a first configuration of a fiber optic transceiver in accordance with some embodiments of the invention;

FIG. 3 illustrates an example memory module of a fiber optic transceiver in accordance with some embodiments of the invention;

FIG. 4 illustrates a first example method related to the first configuration of the fiber optic transceiver of FIG. 2;

FIG. 5 illustrates a second configuration of a fiber optic transceiver in accordance with some embodiments of the invention;

FIG. 6 illustrates a second example method related to the second configuration of the fiber optic transceiver in FIG. 5, among other configurations; and

FIG. 7 illustrates a third configuration of a fiber optic transceiver in accordance with some embodiments of the invention that can implement the second example method of FIG. 6.

### DETAILED DESCRIPTION OF SOME EMBODIMENTS

Challenge/response authentication techniques using strong encryption may be implemented through a serial communications port of a fiber optic transceiver, transponder, or other optoelectronic device. The transceiver may be a stand-alone component or integrated with an active cable and may be adapted to provide independent authentication to a number of different end users. Challenge/response authentication techniques may alternately or additionally be used with passive fiber optic components.

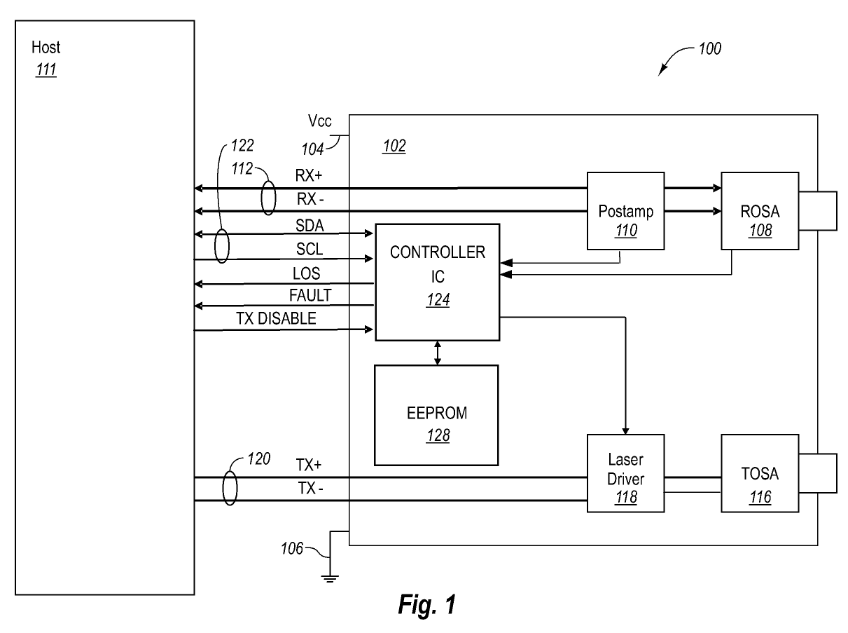

FIG. 1 is a schematic representation of a fiber optic transceiver 100 including its circuitry and components. Fiber optic transceiver 100 may include a circuit board 102 that contains at a minimum a receiver circuit, a transmit circuit, a power connection 104, and a ground connection 106.

The receiver circuit may receive relatively small optical signals at an optical detector and may amplify and limit the signals to create a uniform amplitude digital electronic output. The receiver circuit may consist of a Receiver Optical Subassembly (“ROSA”) 108, which may include a fiber receptacle as well as a photodiode and preamplifier (“preamp”) circuit. ROSA 108 may in turn be connected to a post-amplifier (“postamp”) integrated circuit 110, which may generate a fixed output swing digital signal and may be connected to a host device 111 via high-speed receiver data lines 112 (RX+ and RX−).

The transmitter circuit, or laser driver circuit, may accept high-speed digital data and may electrically drive a Light Emitting Diode (“LED”), laser diode, or other optical signal source, to create equivalent optical pulses. The transmit circuit may consist of a Transmitter Optical Subassembly (“TOSA”) 116 and a laser driver IC 118. TOSA 116 may include a fiber receptacle as well as an optical signal source such as a laser diode or LED. The laser driver IC 118 may include an alternating current (“AC”) driver to provide AC current to the laser diode or LED. The laser driver IC 118 may also include a direct current (“DC”) driver to provide bias current to the laser diode or LED. The signal inputs for the AC driver may be obtained via high-speed transmitter data lines 120 (TX+ and TX−).

Transceiver 100 may include various inputs and/or outputs with respect to host device 111, including, for example, a low-speed serial communications path 122—including a serial clock line (“SCL”) and a serial data line (“SDA”)—a Loss of Signal (“LOS”) indicator to indicate that a receive signal is not detected, and/or a fault indicator to indicate that the transceiver module is running too hot. Optical transceivers employing these input and/or output connections may include a transceiver controller 124 located either within, or outside, transceiver 100.

Transceiver 100 may also include a memory module, such as an Electrically Erasable Programmable Read Only Memory (“EEPROM”) 128, to store information including, for example, standardized serial identification (“ID”) information, readable by transceiver controller 124.

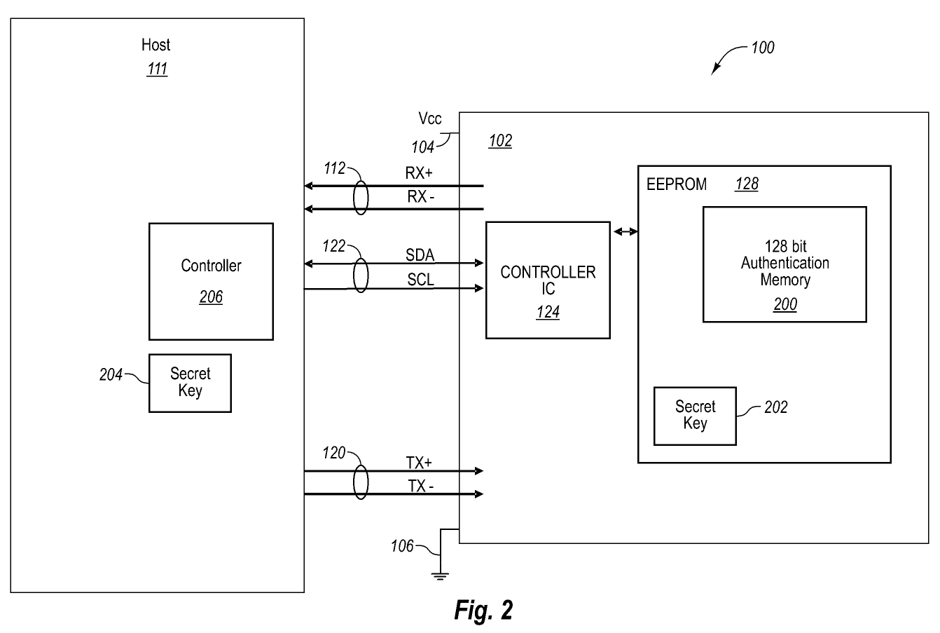

FIG. 2 discloses an example structure for implementing a challenge/response authentication method in transceiver 100. As described above with respect to FIG. 1, host device 111 and transceiver 100 may be connected via high-speed data lines 112 and 120, and low-speed serial communications path 122. Low-speed serial communications path 122 may comply with the I2C standard and may therefore include two electrical lines—SCL and SDA. The I2C protocol defines a master (in this case the host device 111) and a slave (in this case the transceiver 100). I2C commands are read and written to memory locations that are defined by a 7-bit device address and an 8-bit memory address. One memory location in EEPROM 128 may be reserved for authentication purposes as authentication memory 200 and another memory location may be reserved for a transceiver secret key 202. A corresponding memory location may be reserved in host device 111 for a host secret key 204. Host device 111 may also include a host controller 206 operably connected to and adapted to communicate with transceiver controller 124.

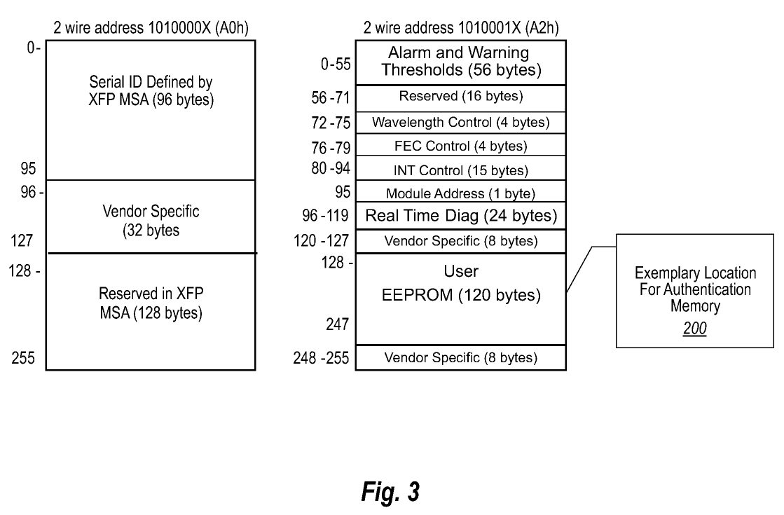

FIG. 3 discloses an example memory map of a portion of EEPROM 128. The SFF-8472 standard defines a set of serial ID, diagnostics, vendor specific, and user writable memory locations in EEPROM 128 using two device addresses, A0h and A2h. Authentication memory 200 (FIG. 2) may be 128 bits (16 bytes) of read/write memory in the address space from bytes 128 to 143 at device address A2h, which is defined as User Writable EEPROM by the SFF-8472 standard.

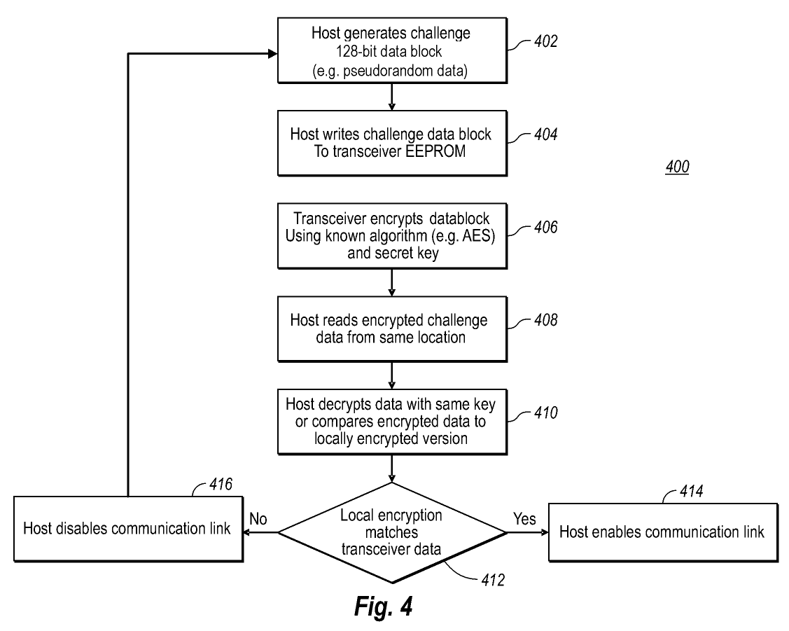

FIG. 4 shows a flow diagram of an example challenge/response authentication method 400 using authentication memory 200. Authentication method 400 may include various stages. First, host device 111 may generate an arbitrary set of data, e.g. pseudorandom data, as a challenge data set or data block (stage 402). Host device 111 may then write the challenge data set to authentication memory 200 (stage 404). Next, using predetermined transceiver secret key 202 stored in EEPROM 128 (see FIG. 3) and a predetermined encryption algorithm, transceiver 100 may encrypt the challenge data set into a response data set, which may replace the original challenge data set from host device 111 (stage 406). Alternately, the transceiver can write the response data set to a different memory location than the challenge data set.

Various different encryption algorithms may be used to encrypt the challenge data depending on design constraints and desired tradeoffs. For example, the encryption algorithm may be publicly available, like the SFF-8472 standard. To increase security, the algorithm may use a sufficiently long key to ensure against attacks such as brute-force attacks that analyze unencrypted and encrypted data set pairs. The challenge data set, secret keys 202 and 204, and the response data set may each be the same size, e.g. 128 bits, or they may be of differing sizes. An encryption algorithm having a relatively simple implementation may be selected in view of the frequently limited computational power and memory available in an optical transceiver. A block cipher, such as Advanced Encryption Standard (“AES”), which has been standardized by the U.S. government, may be used by transceiver 100 at stage 406, for example. See Federal Information Processing Standards Publication 197, Advanced Encryption Standard (AES), Nov. 26, 2001. The AES cipher may work with 128-bit data sets and can use keys of length 128, 192 or 256 bits. Moreover, to guard against replay attacks, the challenge data set generated by host device 111 may vary each time authentication is performed.

After a challenge data set has been encrypted, host device 111 may read the response data set from authentication memory 200 to verify whether transceiver 100 has used the correct predetermined key and encryption algorithm (stage 408). Verification may be performed by comparing the response data set read from transceiver 100 to a data set encrypted by host device 111, or by decrypting the response data set using an inverse algorithm with the same key and comparing it to the original challenge data set written to transceiver 100 (stage 410). For example, the AES cipher has an inverse algorithm which can be used by host device 111 to verify the response data set from transceiver 100 instead of simply encrypting the challenge data and comparing it to the response data from transceiver 100. If host device 111 determines that transceiver 100 is authentic (stage 412), host device 111 may enable a communication link with transceiver 100 (stage 414). Otherwise, host device 111 may disable a communication link with transceiver 100 (stage 416).

The distribution of keys in the above described system and method may be implemented in a number of ways. For example, vendors of host devices and fiber optic components may agree on a secret key to be programmed into fiber optic components and host devices at a manufacturing stage. A second approach, e.g. where all authentic fiber optic components are shipped to end users via the host manufacturer, may include programming new keys into fiber optic components via a write-only interface. Thus, the secret key or keys would be known only to the host manufacturer. Also, if keys are programmed such that they cannot be read (i.e., through write-only interfaces), a key programming method could be made public or standardized. Thus, a third party could potentially write over keys, thereby corrupting an authentic transceiver, but could not create an authentic transceiver without knowledge of manufacturer programmed keys.

To improve the security of a given host vendor's keys, fiber optic components such as transceiver 100 may store a plurality of keys such that each host vendor may be assigned one or more keys unique to that vendor. Using this approach, additional storage may be allocated in EEPROM 128 or transceiver 100 for any additional keys. In addition, host device 111 may specify to transceiver 100 which key should be used to encrypt a challenge data set.

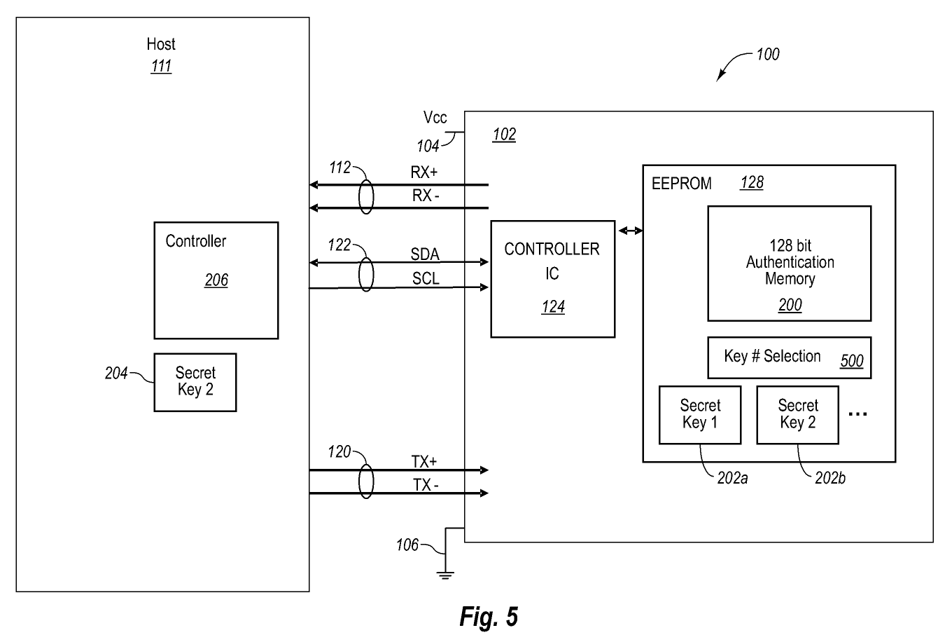

Host device 111 may specify which one of a plurality of keys to use in various ways. For example, in FIG. 5, a memory location in EEPROM 128 separate from authentication memory 200 (i.e., where challenge/response data sets are read and written) may be designated as key number selection memory 500 and various secret keys 202a, 202b, etc., may be stored in write-only memory located within EEPROM 128 or in a separate memory module. Thus, host device 111 may write a key number in key number selection memory 500 when writing a challenge data set to authentication memory 200. Byte 144 of address A2h (see FIG. 3) may be designated as key number selection memory 500, permitting transceiver 100 to differentiate among 256 different keys. For example, a value of 00 h may be provided or assigned, along with a key K00, to host vendor A and a value of 01 h may be provided or assigned, with a different key K01, to host vendor B.

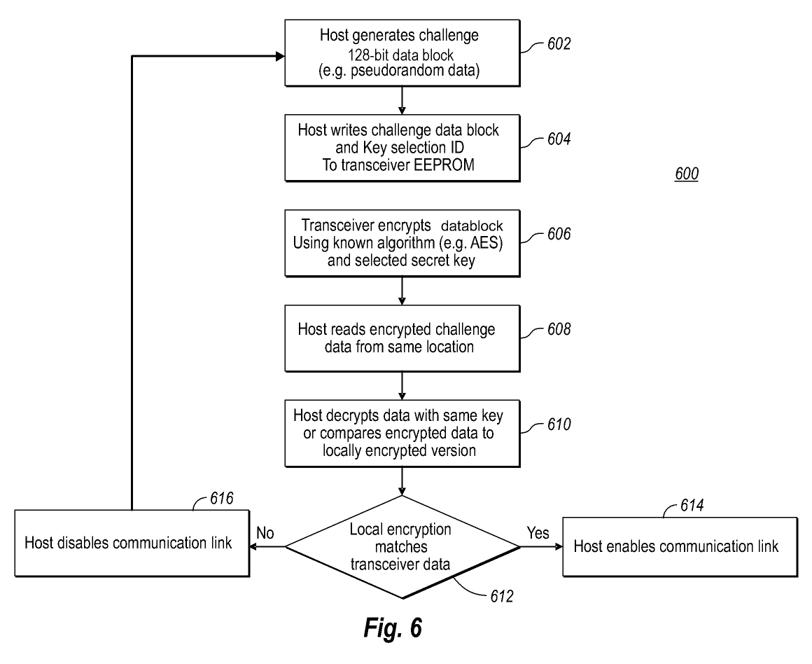

FIG. 6 shows a method 600 that may be implemented by a transceiver configured according to FIG. 5 to authenticate transceiver 100. Stages 602, 608, 610, 612, 614, and 616 in method 600 may be the same as stages 402, 408, 410, 412, 414, and 416, respectively, in method 400 of FIG. 4. Stages 604 and 606 may differ, however, from stages 404 and 406. For example, when writing a challenge data set into bytes 128-143, host device 111 may also write a value, such as 01 h, into byte 144, indicating use of a key associated with a particular host vendor (stage 604). Transceiver 100 may read byte 144 and encrypt the challenge data set with the corresponding selected key K01 (stage 606), writing the resulting response data set to bytes 128-143. Host device 111 may then read bytes 128-143 (stage 608) and verify that the original challenge data set has been encrypted with key K01.

Moreover, with the configuration of FIG. 5, a vendor may have a replacement key programmed into fiber optic components when a key is known to have become compromised. For example, a higher available key number may be associated with a replacement key. Newer host devices (or host devices with updated firmware) could then verify the presence of the replacement key in a fiber optic component.

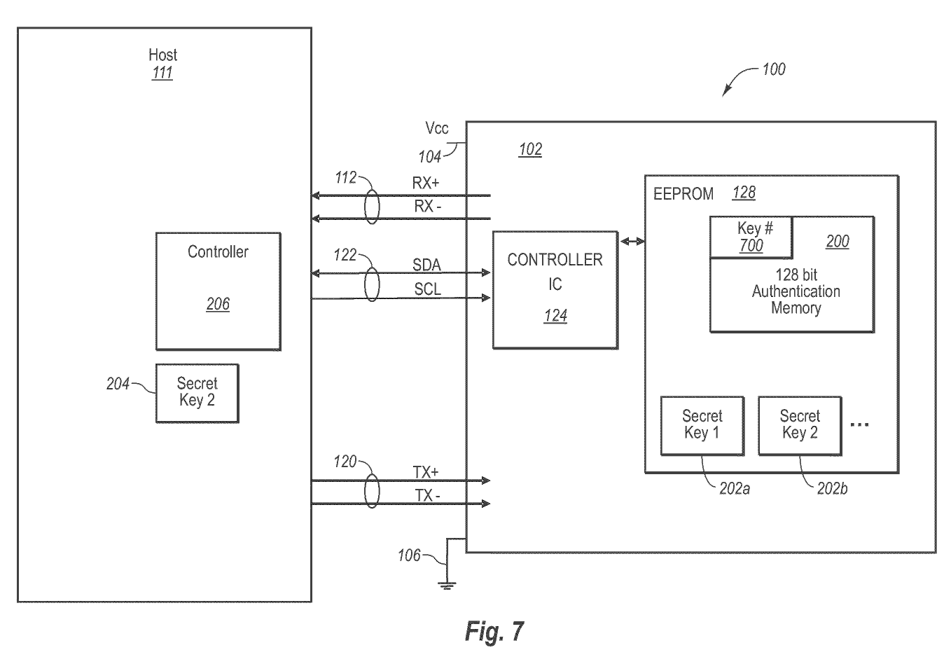

FIG. 7 discloses a second embodiment of a transceiver 100 adapted to distinguish among different host vendor keys. In this embodiment, a key number may be written within authentication memory 200 (i.e., the memory block used for the challenge/response data sets). For example, the first byte of a challenge data set may be designated as a key number 700 for transceiver 100 to read. A challenge data set according to this embodiment would have slightly less arbitrary data, which may be acceptable if, for example, impact on overall security is negligible.

While the embodiments above have been described in the context of fiber optic transceivers, embodiments of the invention can alternately or additionally be implemented in fiber optic transponders and/or other optoelectronic devices.

The above described systems and methods may be implemented using other communications means between host device 111 and transceiver 100. For example, a memory mapped system, including EEPROM 128 may be omitted and a register-based system may instead be implemented. In a register-based system a register may be designated for writing a challenge data set and the same or a different register may be designated for reading an encrypted response data set. Similarly, a write-only register may be designated for programming a secret key into transceiver 100. A key number to be used for encryption may also be written using a register-based system. In addition, the systems and methods described above may be implemented using a command-based interface.

A two-wire serial interface such as I2C for low-speed serial communications path 122 may also be omitted, altered, or replaced. For example, other serial control interfaces, such as a Serial Peripheral Interface (“SPI”), may be used instead. Alternatively, a 1-wire interface may be used if, for example, few pins are available. Regardless of what communications standards are used, low-speed serial communications path 122 may also be shared with other existing pins such that the pins have multiple functions. For example, a fault output pin might also be used as a bidirectional communications pin.

Another alternative may have low-speed data being transferred to and from transceiver 100 over high-speed data lines 112 and/or 120. For example, if high-speed data is encoded so as to not use bandwidth lower than some cutoff frequency, usually defined by the size of AC coupling capacitors, management information, including challenge/response data sets and associated commands, may be transmitted at a lower frequency that is out-of-band with respect to the high-speed data. The data sets and commands may be inserted and read from high-speed data lines 112 and/or 120 in between AC coupling capacitors, which would otherwise block the low frequency transmissions. For example, if transceiver 100 includes AC coupling capacitors on high-speed data lines 112 and/or 120, and no AC coupling capacitors are in host device 111, the challenge/response data sets and commands may be read and written to a host-side of AC coupling capacitors on high-speed data lines 112 and/or 120.

Common mode signaling, suited for low data rates, may also be used to transmit challenge/response data sets and associated commands over a transceiver management interface. Differential lines encode data as voltage differences between inverted and non-inverted lines, but may also carry data in their common mode, i.e., common mode signals, which may be an average voltage of the inverted and noninverted lines. High-speed data lines 112 and 120, for example, may be differential lines over which common mode signals may be transmitted. Thus, high-speed data and low-speed management data may be transmitted simultaneously over a differential signal pair. Either the differential pair of high-speed receiver data lines 112 or the differential pair of high-speed transmitter data lines 120 may be used for a common mode signaling protocol. Alternatively, both pairs may be used for separate functions. For example, transmission from host device 111 to transceiver 110 may occur over high-speed transmitter data lines 120 and data flow in the opposite direction may occur over high-speed receiver data lines 112.

Active cables may also be authenticated with the techniques described above. An active cable may be connected to two different host devices, each made by a different manufacturer. A single common key from the active cable manufacturer may be used by each host device. Alternatively, multiple keys may be used as described above in connection with FIGS. 5-7, allowing a host device manufacturer to verify the authenticity of an active cable without knowing the key used by other host device manufacturers.

The above described systems and methods may also be used in connection with components that do not have dedicated memory. Passive Radio Frequency Identification (“RFID”) tags, for example, which do not rely on memory or power supplied by a component, may permit passive components such as passive fiber optic cables to be authenticated. Moreover, RFID tags respond to wireless interrogation through either active or passive methods. In the case of a passive method, the RFID tag draws power from the interrogating signal, whereas an active method makes use of a local power source. Thus, an optical transceiver may implement either a passive or active RFID technology, in the latter case drawing the power from transceiver power supply connections 104 and 106. Passive RFID technology may be used for completely passive components such as optical fiber cables used in fiber optic connections.

RFID tags may simply send an identification or serial number back to an interrogating system, providing relatively limited anti-counterfeiting value. However, secret key challenge/response techniques, such as those described above, may also be implemented using RFID technology. To accommodate the limited power available when authenticating a passive component, a simple encryption algorithm, e.g. based on a key shorter than 128 bits, may be used. For example, Texas Instruments Digital Signature Transponder (“DST”), which is based on a 40-bit key and 40-bit challenge and response data sets, may be used as the encryption algorithm in a passive RFID tag. Also, when using an RFID tag to authenticate a passive optical cable, the antenna structure of the RFID tag may be integrated into a cable jacket and spread along up to a 90 millimeter length of the cable.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A transceiver comprising:
a transmitter optical subassembly;
a receiver optical subassembly;
a controller operably connected to the transmitter optical subassembly and the receiver optical subassembly; and
a memory module operably connected to the controller circuit and having a key stored therein,
wherein the controller circuit is adapted to authenticate the transceiver by receiving challenge data from a host device and sending encrypted response data to the host device using the key.

2. The transceiver of claim 1, wherein the key is associated with a particular host device manufacturer.

3. The transceiver of claim 1, wherein the memory module has a plurality of keys stored therein, each key being associated with a unique host device manufacturer.

4. The transceiver of claim 3, wherein the controller circuit is further adapted to authenticate the transceiver by receiving a key selection identifier from the host device, the key selection identifier identifying a particular one of the plurality of keys.

5. The transceiver of claim 1, wherein the challenge data set comprises pseudorandom data.

6. The transceiver of claim 1, wherein the challenge data set is different each time the transceiver is authenticated.

7. A system comprising:
a host device; and
a fiber optic component, the fiber optic component comprising:
a controller circuit; and
a memory module operably connected to the controller circuit and having a key stored therein,
wherein the controller circuit is adapted to authenticate the fiber optic component by receiving challenge data from the host device and sending encrypted response data to the host device using the key.

8. The system of claim 7, wherein the host device comprises:
a copy of the key; and
a controller circuit adapted to verify the encrypted response data using the copy of the key.

9. The system of claim 7, wherein the challenge data is generated by the host device and is different each time the fiber optic component is authenticated.

10. The system of claim 7, wherein the fiber optic component comprises an active cable or a fiber optic transceiver.

11. The system of claim 7, wherein the fiber optic component further comprises a Radio Frequency Identification tag configured to receive the challenge data and to send the encrypted response data.

12. The system of claim 7, wherein the host device and fiber optic component implement one of the following systems for communicating the challenge data and encrypted response data between the host device and fiber optic component:
a memory-mapped system;
a register-based system; or
a command-based system.

13. A method of authenticating a fiber optic component, comprising:
a host device generating a challenge data set;
the host device writing the challenge data set to authentication memory of the fiber optic component;
the host device reading a response data set from the authentication memory of the fiber optic component, the response data set comprising an encryption of the challenge data set;
verifying that the response data set is encrypted using a predetermined key and encryption algorithm; and
when the response data set is encrypted using the predetermined key and encryption algorithm, enabling a communication link with the fiber optic component.

14. The method of claim 13, further comprising, when the response data set is not encrypted using the predetermined key or encryption algorithm, disabling the communication link with the fiber optic component.

15. The method of claim 13, wherein verifying that the response data set is encrypted using a predetermined key and encryption algorithm comprises:
the host device encrypting the challenge data set using the predetermined key and encryption algorithm to generate a local encrypted data set; and
the host device comparing the local encrypted data set to the response data set.

16. The method of claim 13, wherein verifying that the response data set is encrypted using a predetermined key and encryption algorithm comprises:
the host device decrypting the response data set using the predetermined key and an algorithm that is an inverse of the encryption algorithm to generate a decrypted data set; and
the host device comparing the local decrypted data set to the challenge data set.

17. The method of claim 13, further comprising, after the host device writes the challenge data set to authentication memory of the fiber optic component:
the fiber optic component encrypting the challenge data set using the predetermined key and encryption algorithm to generate the response data set; and
the fiber optic component writing the response data set to the authentication memory;
wherein the fiber optic component stores the predetermined key in a memory module of the fiber optic component.

18. The method of claim 17, further comprising, the host device writing a key selection identifier to the memory module, the key selection identifier indicating the use of the predetermined key from among a plurality of keys stored in the memory module.
